(19) United States
(12) Patent Application Publication
(10) Pub. No.: US 2013/0147973 A1
(43) Pub. Date: Jun. 13, 2013

(54) Wireless Camera Data Management

(71) Applicant: MICROPOWER TECHNOLOGIES, INC., San Diego, CA (US)

(72) Inventors: Christopher Williams, San Diego, CA (US); Jon Siann, Rancho Santa Fe, CA (US)

(73) Assignee: MICROPOWER TECHNOLOGIES, INC., San Diego, CA (US)

(21) Appl. No.: 13/708,977

(22) Filed: Dec. 8, 2012

Related U.S. Application Data
(60) Provisional application No. 61/569,208, filed on Dec. 9, 2011.

(51) Int. Cl. H04N 5/232

(52) U.S. Cl. CPC H04N 5/23203
USPC 348/207.1

(57) ABSTRACT

Disclosed herein is a wireless camera data management method in which a hub is used to monitor data on a wireless channel between the hub and a first camera. The first camera is located physically away from the hub. The hub is used to monitor data on the wireless channel between the hub and a second camera. The second camera is located physically away from the hub. When the wireless channel exhibits excessive data traffic, camera data transmitted from the first or second camera is reduced by at least one of the following: (i) reducing a frame rate of the camera data, (ii) reducing the resolution of the camera data, (iii) reducing the bit rate of the camera data by increased compression, (iv) using frame modulation on the camera data, or (v) prioritizing data transmitted by the first camera or the second camera based on a first user input.

### CROSS REFERENCE TO RELATED APPLICATIONS

This application claims priority benefit to U.S. Provisional Application No. 61/569,208, entitled “Wireless Camera Data Communication” filed Dec. 9, 2011, which is incorporated by reference in its entirety herein as if it was put forth in full below.

### BACKGROUND

Network camera systems can be based on Internet protocol (IP) and use Ethernet based networking technology. In some applications, network camera systems are replacing analog closed circuit television (CCTV) due to various factors, such as accessibility, ease-of-use, cabling scalability, and lower cost of deployment and operation. With the ubiquity of wireless networks such as WiFi networks (based on IEEE 802.11 standards) and the emerging WiMAX networks (based on IEEE 802.16 standards), wireless network camera systems are gaining popularity and may become the dominant platform for video surveillance applications.

In an IP surveillance environment, a network camera system can include IP cameras connected via twisted pair cabling to a network switch. Alternatively, the network connection can be achieved using wireless local area networking (LAN) technology standard. In various applications, IP cameras can include a web-server capability and remote clients or observers connected to the camera via standard TCP/IP interface standards such as FTP or HTTP. IP based network camera systems can be designed using commercial off-the-shelf (COTS) components from a diverse number of suppliers.

### SUMMARY

Disclosed herein is a wireless camera data management method in which a hub is used to monitor data on a wireless channel between the hub and a first camera. The first camera is located physically away from the hub. The hub is used to monitor data on the wireless channel between the hub and a second camera. The second camera is located physically away from the hub. When the wireless channel exhibits excessive data traffic, camera data transmitted from the first camera or the second camera is reduced by at least one of the following: (i) reducing a frame rate of the camera data, (ii) reducing the resolution of the camera data, (iii) reducing the bit rate of the camera data by increased compression, (iv) using frame modulation on the camera data, or (v) prioritizing data transmitted by the first camera or the second camera based on a first user input.

The present invention is better understood upon consideration of the detailed description below in conjunction with the accompanying drawings and claims.

### BRIEF DESCRIPTION OF DRAWINGS

FIG. 1 illustrates an example environment for a wireless camera data management method;

FIG. 2 provides a flowchart of an example of a message authentication code (MAC) algorithm; and

FIG. 3 depicts example embodiments of a wireless camera data management method.

FIG. 4 is an example embodiment of a wireless camera data management method.

### DETAILED DESCRIPTION

The present invention is a wireless camera data management method in which a hub is used to monitor data on a wireless channel between the hub and a first camera. The first camera is located physically away from the hub. The hub is used to monitor data on the wireless channel between the hub and a second camera. The second camera is located physically away from the hub. When the wireless channel exhibits excessive data traffic, camera data transmitted from the first camera or the second camera is reduced by at least one of the following: (i) reducing a frame rate of the camera data, (ii) reducing the resolution of the camera data, (iii) reducing the bit rate of the camera data by increased compression, (iv) using frame modulation on the camera data, or (v) prioritizing data transmitted by the first camera or the second camera based on a first user input.

In one embodiment, the primary focus of the first camera and the second camera is collecting video data. The step of reducing the frame rate of the camera data may be done after receiving a second user input.

In another embodiment, the hub is located in a base station. The hub may communicate with other hubs or a base station and may direct another hub to transmit the camera data.

The first and/or second cameras may be wearable and weigh less than about 50 grams. In one mode of operation, the first user may be physically located near the first or the second camera and provides the input by interfacing directly with the first or the second camera. The input from the first user may be received via a user interface provided by a software application. In one embodiment, the sending of the camera data is done in a round-robin fashion.

Also disclosed herein is a method for monitoring a wireless camera data communication system, where the wireless camera data communication system includes a first camera, a second camera and a hub. The method comprises receiving camera data from the first or second camera. Next, data is monitored on a wireless channel between the hub and the first camera where the first camera is located physically away from the hub. Data is also monitored on the wireless channel between the hub and the second camera where the second camera is located physically away from the hub. Finally, camera data transmitted from the first camera or the second camera when the wireless channel exhibits excessive data traffic is reduced by at least one of the following steps: (i) reducing a frame rate of the camera data, (ii) reducing the resolution of the camera data, (iii) reducing the bit rate of the camera data by increased compression, (iv) using frame modulation on the camera data, (v) prioritizing data transmitted by the first camera or the second camera based on a first user input.

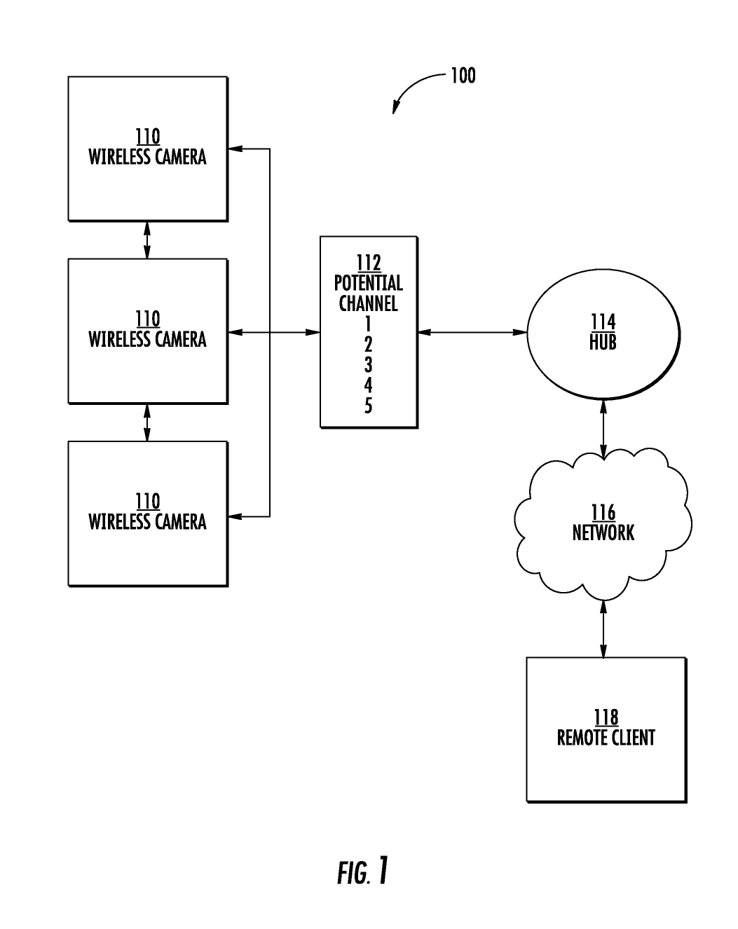

FIG. 1 illustrates an example environment for a wireless camera data management method 100. In this example, a network camera system includes a plurality of wireless cameras 110. A plurality of wireless cameras 110 may optionally communicate with one another. Wireless cameras 110 transmit data to a hub 114, which is optionally located in a base station, via a potential channel 112. A plurality of wireless cameras may also be associated with two hubs, or base stations, to provide redundancy in case one of the hubs experiences a failure and cannot transmit data. Furthermore, a plurality of wireless cameras may be associated with a plurality of hubs, or base stations, in a mesh-architecture to maximize redundancy, robustness, integrity, resiliency and low power operation.

Hub 114 is configured to receive information from the one or more wireless cameras 110 and scans one or more potential communication channels 112 for channel availability between hub 114 and wireless cameras 110. Once an available channel 112 is obtained for data transmission based on the scanning of channel availability, the available channel 112 is associated with a specific wireless camera 110. The associating of the available channel 112 may include reserving the available channel 112 for a predetermined period of time, and assigning the reserved available channel 112 to the specific wireless cameras. In addition, during the predetermined period of time, available channel 112 may appear to other wireless cameras 110 as unavailable for wireless communication in one embodiment, or may appear as available for wireless communication in another embodiment.

A network 116 connects hub 114 with the remote client 118 through a wireless network (e.g., a Bluetooth connection, a cellular network, a wireless Ethernet network, a WiFi network, or a WiMAX network) or a wired network (e.g., LAN/WAN network, or POE network). Remote client 118 may be a device such as a mobile phone, personal digital assistance (PDA), smartphone, laptop, computer or the like.

In one embodiment, hub 114 processes the received information. In another embodiment, hub 114 may also be one or more devices such as computers receiving and processing the information as a wireless base station 114. Hence, the computers may function as base station 114 as well as remote client 118.

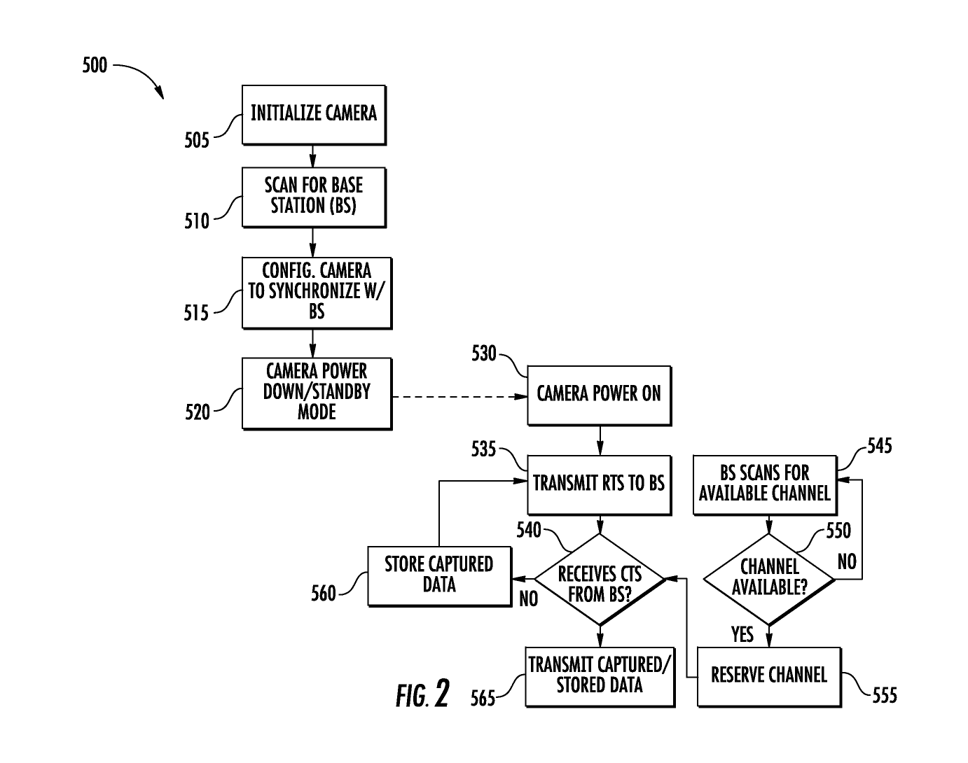

FIG. 2 shows a flowchart of an example message authentication code (MAC) algorithm 500 that can be used by the wireless camera. At step 505, the wireless camera is initialized by going through a discovery mode. At step 510, the wireless camera scans for the hub, which may be a base station. At step 515, the system configures the wireless camera to synchronize with the hub (or base station). Once the wireless camera has been initialized and synchronized with a hub, the camera can then enter a power down or standby mode, at step 520, when the camera is inactive. On the other hand, based on a triggering event, at step 530, the camera can be powered on and enter active mode.

Once the camera is powered on, at step 535, the camera transmits a Request to Send (RTS) frame to the hub. If a channel is available, the hub can then reply with a Clear to Send (CTS) frame. At step 540, the system determines whether a CTS frame is received from the hub. If the CTS frame is received, at step 565, the camera starts to transmit captured or stored image data. On the other hand, if the CTS is not received from the hub, at step 560, the camera stores the captured data in the storage device, and periodically transmits a RTS frame to the hub.

In addition, once the RTS frame has been received by the hub, the hub scans for available channels, at step 545. At step 550, the hub determines whether there are available channels to establish connection with the wireless camera. If there is an available channel, at step 555, the hub reserves the channel and then sends a CTS frame to the camera. On the other hand, if there is no available channel, the hub keeps scanning for available channels. The camera transmits the image data to the hub via bulk transmission channel reserved by the hub, and this image data is received by the hub via a high-bandwidth channel.

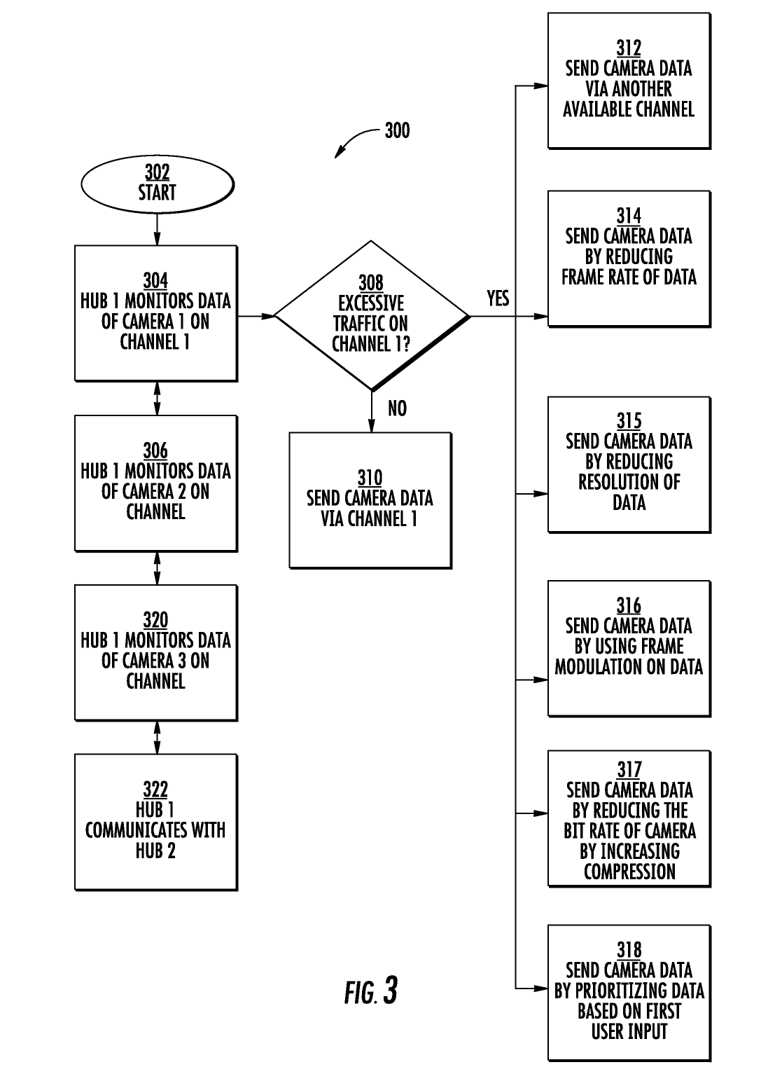

FIG. 3 depicts example embodiments of a wireless camera data management method 300. The primary focus of the first camera and the second camera, or any camera, may be collecting video data. As depicted in FIG. 2, a network of wireless cameras is used to collect image data. These wireless cameras may be permanently mounted such as on a pole or on a side of a building, or temporarily mounted arranged in a wearable form factor such as on clothing (hat, belt or the like) and may weigh less than 50 grams. The first user may be physically located near the first or the second camera and may provide the input by interfacing directly with the first or the second camera.. For example, there may be a button located on the camera, and when the user presses the button, a signal is sent to the hub indicating that image data from that camera should be assigned a high priority. The wireless cameras are associated with a hub and transmit image data over channels as described above.

The process starts at step 302. At step 304, a hub, or hub1, which may be located in a base station, monitors data of a first camera, or camera1, on a reserved wireless channel, or channel1. Hence, channel1 is between hub1 and camera1. Camera1 is located physically away from hub1. The wireless cameras in the network may be permanently mounted such as on a pole or on a side of a building, or temporarily mounted such as on a hat worn by a person or on an instrument panel of a vehicle. The hubs/base stations may be located, for example, in a vehicle, at a remote location or the like.

Hub1 also monitors data on the wireless channel, at step 306, between hub1 and a second camera, or camera2. Further, hub1 also monitors data on the wireless channel, at step 320, between hub1 and a third camera, or camera3. Additional cameras and channels can be used in a similar manner. Again, in this embodiment, all cameras are located physically away from hub1. The wireless channel may be the same as channel1 or a different wireless channel.

It is known in the art that many different consumers use the same channel for transmitting data. As a result, the traffic on the channel may become heavy and therefore difficult to transmit data in a timely fashion, if at all. At step 308, hub1 determines if excessive traffic is encountered on channel1. If not, then at step 310, the data from camera1 is transmitted via channel1. However, when channel1 exhibits excessive data traffic, reducing camera data transmitted from the first camera or the second camera is necessary.

In one embodiment, when the reserved available channel exhibits an excessive amount of traffic, re-routing of the data is used. This is accomplished by the hub scanning other channels for availability as detailed above. The hub may then switch to a new channel with less traffic to transmit the data. At step 312, hub1 scans other available channels until a channel is found that exhibits less data traffic. Hub1 then reserves this new channel and the data from camera1 is then sent on this new channel. Hub1 may also optionally communicate with other hubs/base stations such as at step 322. Here, hub1 may direct another hub such as hub2 to switch to the same new channel that has less traffic to transmit their data.

In one mode, the camera data sent via the second wireless channel, or the new reserved channel that exhibits less data traffic than the original reserved, high-traffic channel, may be done in a round-robin fashion. Here, the first camera data from the first camera is transmitted, then with the second camera data for the second camera, next the third camera data for the third camera, then with the fourth camera data from a fourth camera, etc. A beeping sound or light signal may be emitted from each of the cameras to indicate when the round-robin mode is activated. This alerts the user that camera data may not be captured or may be delayed. This alert may be used in other circumstances where data is not being relayed or is being delayed, and thus is not limited to the round-robin scenario.

In another embodiment, when the reserved available channel exhibits an excessive amount of traffic, the hub may transmit the camera data at a reduced frame rate to compensate for other traffic on the same channel. In one mode, reducing the frame rate of the camera data is done after receiving a second user input. Frame rate, also known as frame frequency, is the frequency at which an imaging device produces unique consecutive images called frames. Wireless network camera operation can be achieved, for example, at full-motion frame rates in excess of 10 frames per second at a resolution of 320×240 pixels. By reducing the frame rate to a lower frequency of, for example, 5 frames per second, the image quality is retained with a reduced frame frequency. Therefore the granularity of motion that is visible from frame to frame will be lower.

At step 314, hub1 directs cameral to transmit the camera data via channel1 by reducing the frame rate of the data. In this way, the amount of bandwidth needed to transmit the data is reduced. Although the amount of data being sent is reduced and the quality of the motion displayed is decreased, the data can still be sent on the busy channel.

Sending the camera data at a reduced frame rate may be done in response to receiving a second input from a user. For example, a camera may be arranged in a wearable form factor such as on clothing worn by a user. The user may depress a distinct button on the camera which will reduce the frame rate of the data transmitted. This may be useful when the data being transmitted has a low priority.

In another embodiment, when the reserved available channel exhibits an excessive amount of traffic, at step 315, the camera data or images are transmitted with a lower pixel resolution. This may for example reduce the image pixel resolution from 640×480 to 320'240. The reduction in resolution will decrease the amount of data that must be transmitted per frame. This image resolution reduction can be achieved by down sampling. In another mode for optimization, the camera sends portions of the image at a time or sends zoomed-in image information (to best fit to the smaller screen and lower network bandwidth of the handheld device).

In a further embodiment, when the reserved available channel exhibits an excessive amount of traffic, the hub may stay on the reserved, high-traffic channel but use frame modulation techniques on the data such as OFDM, spread spectrum or the like. Orthogonal frequency-division multiplexing (OFDM) is a method of encoding digital data on multiple carrier frequencies and is used as a digital multi-carrier modulation method. It has developed into a popular scheme for wideband digital communication. In one implementation, a multi-carrier modulation technique such as OFDM can be used where an 802.11 based physical layer technology is utilized to transfer the bulk data. The physical layer technology used can include broadband high efficiency OFDM modulation architectures. The OFDM modulation technique can exhibit low energy per bit transferred per unit of range vs. other commonly used radio link architectures, such as the 802.15.4 OOC/FSK modulation techniques.

In another implementation, a spread spectrum modulation scheme such as code division multiple access (CDMA) is used. CDMA is a channel access method used by various radio communication technologies. One of the basic concepts in data communication is the idea of allowing several transmitters to send information simultaneously over a single communication channel. This allows several users to share a band of frequencies and is known as multiple access. CDMA employs spread-spectrum technology and a special coding scheme (where each transmitter is assigned a code) to allow multiple users to be multiplexed over the same physical channel.

At step 316, hub1 directs cameral to transmit the data via channel1 by using frame modulation on the data. In this way, the amount of bandwidth needed to transmit the data is reduced so the data can be sent on the busy channel.

In a further embodiment, when the reserved available channel exhibits an excessive amount of traffic, at step 317, the bit rate of the camera data may be reduced by increased spacial or motion compression. Spacial compression reduces the information present in an individual frame. Increased compression involves removing the least important visual information; higher levels of compression remove more information and enable a reduction in the transmission bandwidth consumed. For example, JPEG image compression uses a filter that corresponds to the human visual perception to remove frequencies that are least significant visually, resulting in less information, but retaining the most important parts. Increasing levels of compression reduce the amount of information in the image. Depending on the application, there is a threshold beyond which the image is unsatisfactory. Motion compression, both lossy and lossless, are alternate and complementary compression methods that can be employed to reduce the bandwidth required to transmit successive frames.

In yet another embodiment, when the reserved available channel exhibits an excessive amount of traffic, the hub may prioritize the data transmitted on the wireless channel by the first camera or the second camera based on a first user input (step 318). For instance, when a camera from an emergency organization such as police, fire or emergency medical services (EMS) transmits a RTS frame to the hub in the base station, the hub may grant priority for transmittal of that data. This may be accomplished via a user interface provided by a software application in the camera, hub, wireless network or wired network or a combination thereof. In one implementation, the hub may be monitored by a user to insure the emergency organization has priority when necessary for data transmittal.

The emergency organization may have the camera mounted in or on a vehicle or on clothing such as on a hat or belt. The camera may contain a distinct button and when depressed, the base station is informed to raise the priority level on that particular camera.

In another mode, the user may be alerted that camera data is not being relayed or is being delayed. The user may provide feedback to reverse this process by prioritizing data transmitted by the first camera or the second camera based on a first user input. Referring to step 318, for example, the user may interface directly with the camera via a button or other physical device to send a signal to the hub to increase the priority for the camera data. The user may also interface with the hub to increase the priority for the camera data by utilizing a user interface provided by a software application. This may be done using cloud computing or a proprietary network or the like.

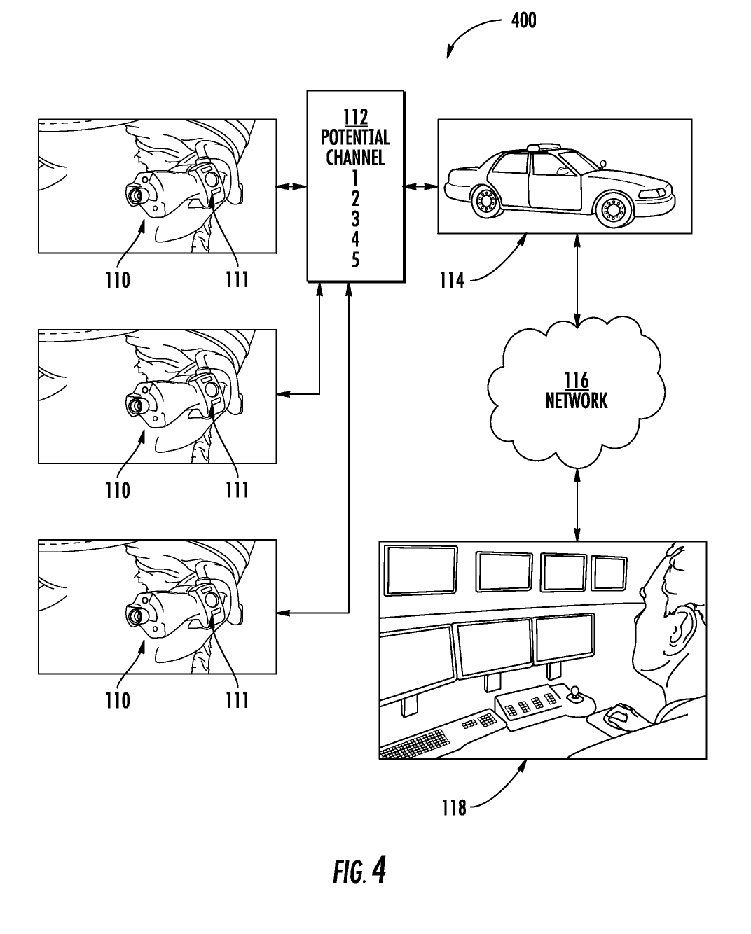

In a specific example, referring to FIG. 4, at the scene of an accident with a fire, multiple emergency and law enforcement officials may arrive to provide assistance and monitor the scene. These law enforcement officials have wearable wireless cameras 110 with a button 111. If many of these officials have wireless cameras 110, wireless communication channels 112 may become full with the real-time video data from cameras 110. If a fire rescue person observes someone in need of assistance, that rescue person may press a button 111 on or near their wireless camera 110 to provide a priority signal to the hub or base station 114 ensuring video data is not degraded or delayed for that particular camera. Hub or base station 114 is located in the law enforcement official's vehicle and transmits the data through a network 116 to remote client 118. In this case, remote client 118 is located at the law enforcement official's office and is monitored by another law enforcement official.

Alternatively, another user may be viewing camera data from multiple wireless cameras at the scene. This monitoring user may be located at the scene (e.g., in a surveillance van) or away from the scene (e.g., at police headquarters). The monitoring user may observe that the fire rescue person is assisting someone where camera monitoring would be greatly beneficial. In response, the monitoring user directs the hub to provide the rescue person's camera with the highest priority for video data transmission. This may be done via any communication method available, both public or proprietary.

In another embodiment, each rescue and enforcement official may have a predetermined priority for camera data transmission. In this embodiment, FBI may have priority over local police who have priority over fire rescue personal. When the wireless communication channels become full in this example, camera data from FBI cameras automatically takes priority over the other cameras at the scene.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

1. A wireless camera data management method, the method comprising the steps of:
using a hub to monitor data on a wireless channel between the hub and a first camera, the first camera being located physically away from the hub;
using the hub to monitor data on the wireless channel between the hub and a second camera, the second camera being located physically away from the hub; and
when the wireless channel exhibits excessive data traffic, reducing camera data transmitted from the first camera or the second camera by at least one of the following steps:
(i) reducing a frame rate of the camera data; or
(ii) reducing the resolution of the camera data; or
(iii) reducing the bit rate of the camera data by increased compression; or
(iv) using frame modulation on the camera data; or
(v) prioritizing data transmitted by the first camera or the second camera based on a first user input.

2. The wireless camera data management method of claim 1, wherein the primary focus of the first camera and the second camera is collecting video data.

3. The wireless camera data management method of claim 1, wherein the hub is located in a base station.

4. The wireless camera data management method of claim 1, wherein the first user is physically located near the first or the second camera and provides the input by interfacing directly with the first or the second camera.

5. The wireless camera data management method of claim 1, wherein the input from the first user is received via a user interface provided by a software application.

6. The wireless camera data management method of claim 1, wherein the sending of the camera data is done in a round-robin fashion.

7. The wireless camera data management method of claim 1, wherein the step of reducing the frame rate of the camera data is done after receiving a second user input.

8. The wireless camera data communication method of claim 1, wherein the first and/or second cameras are wearable and weigh less than about 50 grams.

9. The wireless camera data communication method of claim 1, wherein the hub communicates with other hubs or a base station.

10. The wireless camera data communication method of claim 1, wherein the hub directs another hub to receive the camera data.

11. The wireless camera data communication method of claim 1, further comprising: when the wireless channel exhibits excessive data traffic, reducing camera data transmitted from the first camera or the second camera by sending the camera data via the second wireless channel when the second wireless channel exhibits less data traffic.

12. A method for monitoring a wireless camera data communication system, the wireless camera data communication system including a first camera, a second camera and a hub, the method comprising:
receiving camera data from the first or second camera;
monitoring data on a wireless channel between the hub and the first camera, the first camera being located physically away from the hub;
monitoring data on the wireless channel between the hub and the second camera, the second camera being located physically away from the hub;
reducing camera data transmitted from the first camera or the second camera when the wireless channel exhibits excessive data traffic, by at least one of the following steps:
(i) reducing a frame rate of the camera data; or
(ii) reducing the resolution of the camera data; or
(iii) reducing the bit rate of the camera data by increased compression; or
(iv) using frame modulation on the camera data; or
(v) prioritizing data transmitted by the first camera or the second camera based on a first user input.

13. The wireless camera data management system of claim 12, wherein the primary focus of the first camera and the second camera is collecting video data.

14. The wireless camera data management system of claim 12, wherein the hub is located in a base station.

15. The wireless camera data management system of claim 12, wherein the first user is physically located near the first or the second camera and provides the input by interfacing directly with the first or the second camera.

16. The wireless camera data management system of claim 12, wherein the input from the first user is received via a user interface provided by a software application.

17. The wireless camera data management system of claim 12, wherein the step of reducing the frame rate of the camera data is done after receiving a second user input.

18. The wireless camera data communication system of claim 12, wherein the first and/or second cameras are wearable and weigh less than about 50 grams.

19. The wireless camera data communication system of claim 12, wherein the hub communicates with other hubs or a base station.

20. The wireless camera data communication system of claim 12, wherein the hub directs another hub to transmit camera data.

21. The wireless camera data communication system of claim 12, wherein when the wireless channel exhibits excessive data traffic, the camera data transmitted from the first camera or the second camera is reduced by sending the camera data via the second wireless channel when the second wireless channel exhibits less data traffic.
